(19) United States
(12) Patent Application Publication
(10) Pub. No.: US 2012/0308115 A1
(43) Pub. Date: Dec. 6, 2012

(54) Method for Adjusting 3-D Images by Using Human Visual Model

(75) Inventor: Wei-Ting Sun, Tainan City (TW)

(73) Assignee: HIMAX MEDIA SOLUTIONS, INC., Tainan City (TW)

(21) Appl. No.: 13/152,066

(22) Filed: Jun. 2, 2011

(51) Int. Cl. G06K 9/00

(52) U.S. Cl. 382/154

(57) ABSTRACT

The present disclosure provides a method for adjusting 3-D images converted from 2-D images by using a human visual model. Steps of the method include inputting a 2-D image, dividing the 2-D image into a plurality of blocks, forming a matrix of blocks, obtaining a depth value of each of the plurality of blocks, adjusting the depth value of each of the plurality of blocks according to a position of each of the plurality of blocks, obtaining adjusted depth information of the 2-D image, wherein the adjusted depth information comprises an adjusted depth value of each of the plurality of blocks of the 2-D image, and using depth image based rendering (DIBR) to generate a set of 3-D images according to the adjusted depth information and the 2-D image.

### BACKGROUND OF THE INVENTION

1. Field of the Invention

The invention relates to technology of converting 2-D images into 3-D images and more particularly to adjusting 3-D images converted from 2-D images according to a human visual model.

2. Description of the Related Art

3-D image or video technology has developed rapidly, recently. 3-D scenes are reconstructed by methods such as stereovision or structure from motion, which require two or more images.

Additionally, 3-D images are reconstructed by methods which require a single image. When reconstructing a 3-D image from a single image, depth information from an original image is first estimated and a second view image based on the estimated depth information and the original image synthesized. A set of 3-D images comprises at least the original image and the second view image. Viewers can get a sense of a 3-D scene from the set of 3-D images because of the binocular parallax of human beings. There are several ways to estimate depth information from an image, for example, by estimating depth from blurs or based on vanishing points.

Nevertheless, the 3-D effect produced by the set of 3-D images may not comfortably match with the eyes of human beings. That is, when seeing the set of 3-D images, a human being may feel uncomfortable.

### BRIEF SUMMARY OF THE INVENTION

In view of this, the invention provides a method for adjusting 3-D images by using a human visual model to make viewers feel more comfortable when seeing 3-D images.

In one embodiment, the invention provides a method for adjusting 3-D images converted from 2-D images, comprising: inputting a 2-D image; dividing the 2-D image into a plurality of blocks, forming a matrix of blocks; obtaining a depth value of each of the plurality of blocks according to a specific algorithm; adjusting the depth value of each of the plurality of blocks according to a position of each of the plurality of blocks; obtaining adjusted depth information of the 2-D image, wherein the adjusted depth information comprises an adjusted depth value of each of the plurality of blocks of the 2-D image; and using depth image based rendering (DIBR) to generate a set of 3-D images according to the adjusted depth information and the 2-D image.

In another embodiment, the invention provides an apparatus for generating 3-D images converted from 2-D images, comprising: an input unit, receiving an input 2-D image; a depth estimating unit coupled to the input unit, dividing the input 2-D image into a plurality of blocks and obtaining a depth value of each of the plurality of blocks according to a specific algorithm, wherein the plurality of blocks forms a matrix; an adjusting unit coupled to the depth estimating unit, adjusting the depth value of each of the plurality of blocks according to a position of each of the plurality of blocks and generating adjusted depth information of the input 2-D image, wherein the adjusted depth information comprises an adjusted depth value of each of the plurality of blocks of the 2-D image; and a DIBR unit coupled to the input unit and the adjusting unit, using depth image based rendering (DIBR) to generate a set of 3-D images according to the adjusted depth information and the 2-D image.

In still another embodiment, the invention provides a computer program product loaded by an electronic apparatus to execute a method for adjusting 3-D images converted from 2-D images, comprising: a first code, receiving an input 2-D image; a second code, dividing the input 2-D image into a plurality of blocks and obtaining a depth value of each of the plurality of blocks, wherein the plurality of blocks forms a matrix; a third code, adjusting the depth value of each of the plurality of blocks according to a position of each of the plurality of blocks and generating adjusted depth information of the input 2-D image, wherein the adjusted depth information comprises an adjusted depth value of each of the plurality of blocks of the 2-D image; and a fourth code, using depth image based rendering (DIBR) to generate a set of 3-D images according to the adjusted depth information and the 2-D image.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of an exemplary embodiment of a method for adjusting 3-D images converted from 2-D images;

FIG. 2 is an exemplary embodiment of an input 2-D image;

FIG. 3a is an exemplary embodiment of the relationship between x-coordinates of the input 2-D image and corresponding X-weightings;

FIG. 3b is an exemplary embodiment of the relationship between y-coordinates of the input 2-D image and a corresponding Y-weightings; and

FIG. 4 is a block diagram of an exemplary embodiment of an apparatus for adjusting 3-D images converted from 2-D images.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

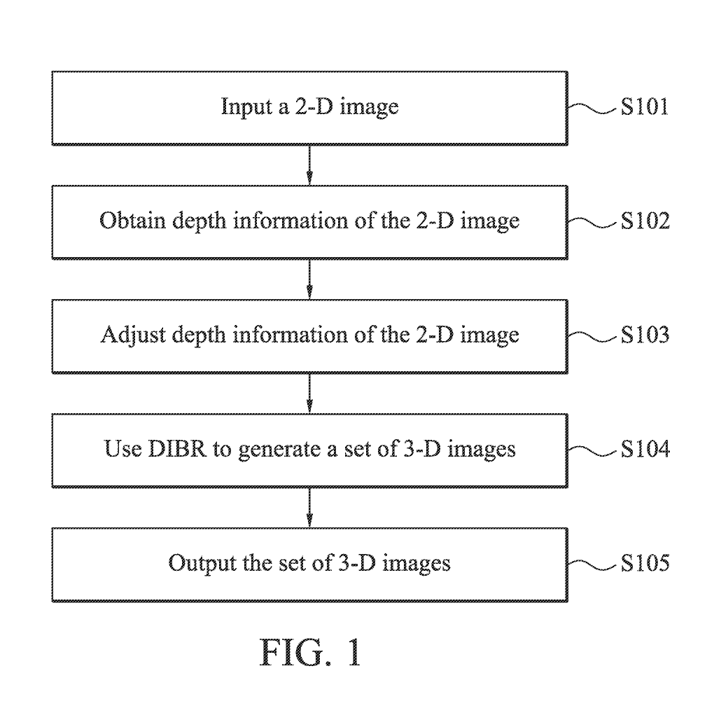

FIG. 1 is a flowchart of an exemplary embodiment of a method for adjusting 3-D images converted from 2-D images.

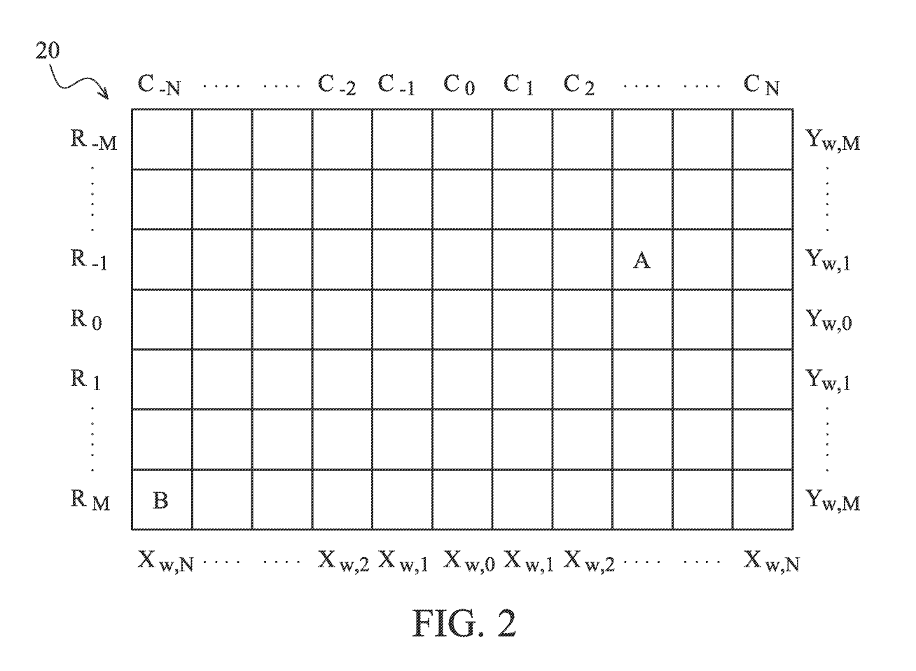

In step S101, a 2-D image is inputted. In step S102, depth information of the 2-D image is obtained. In one embodiment, the 2-D image 20 can be divided into a plurality of blocks, forming a matrix of blocks, as shown in FIG. 2. In FIG. 2, the input image is divided into 2N+1 columns (columns C₀, C₁, C₂, . . . C_{N}, C₋₁, C₋₂, . . . C_{-N}) and 2M+1 rows (rows R₀, R₁, R₂, . . . R_{M}, R₋₁, R₋₂, . . . R_{-M}), wherein N and M are positive integers. Then depth estimation is used, such as estimating depth from blurs or estimating depth based on vanishing points, to obtain a depth value of each block. Each block comprises at least one pixel. Note that the number of columns and rows are not limited to being an odd number of columns and rows.

Concerning the vision of a human, once the fields of view of two eyes overlap, there is a potential for confusion over an object between the images of the left and right eye, which is known as double vision or diplopia. This problem can be dealt with by fusing two retinal images. Panum's fusion area is the region that straddles the horopter. Within the Panum's fusion area binocular single vision takes place, that is, the two images are fused into a single image with depth information. Since the horopter is a curved line which approximates to a parabolic curve, the invention adjusts depth information of the 2-D image according to a curved line which approximates to a parabolic curve, as shown in step S103.

In one embodiment, in step 103, the depth value of each block is adjusted according to a position of each block. The depth value of each of the plurality of blocks is multiplied by a corresponding weighting. The weighting corresponding to the central blocks of the plurality of blocks on the one-dimensional direction (ex: x-direction or y-direction) of the 2-D image has the largest value. The further away a block of the plurality of blocks is from the central blocks of the plurality of blocks on the one-dimensional direction of the 2-D image, the smaller the value of the weighting corresponding thereto is. For example, in step S103, the depth value of each block in FIG. 2 is multiplied by an X-weighting corresponding to a column where each block belongs. In FIG. 2, column C₀ corresponds to X-weighting X_{w,0}, column C₁ and C₋₁ correspond to X-weighting X_{w,1}, column C₂ and C₋₂ correspond to X-weighting X_{w,2}, and so forth. Take block A in FIG. 2 as an example, because block A is at column C₂, the depth value of block A is multiplied by X_{w,2}. That is, D_{A,adjusted}=X_{w,2}×D_{A}, wherein D_{A,adjusted} is the adjusted depth value of block A and D_{A} is the original depth value of block A. Concerning the values of the X-weightings, for example, X_{w,0} is 1 and X_{w,N} is 0, and the values from X_{w,0} to X_{w,N} are descending.

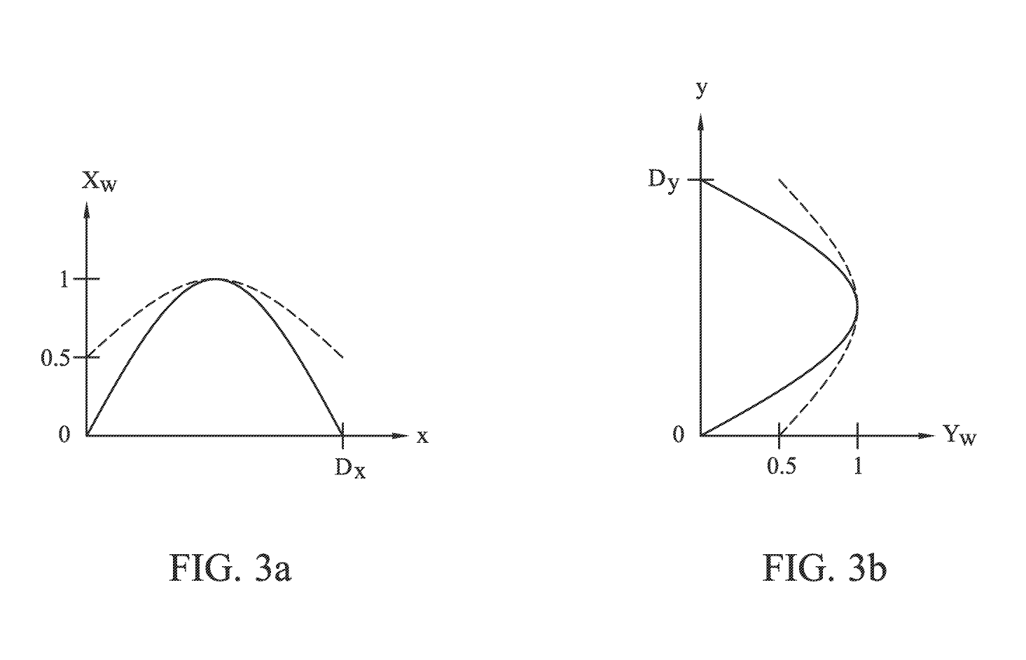

In another example, in step S103, the depth value of each block is multiplied by an X-weighting corresponding to an x-coordinate of each block, as shown in FIG. 3a. FIG. 3a shows the relationship between x-coordinates of the input 2-D image and corresponding X-weightings. The curve representing the relationship between x-coordinates and corresponding X-weightings can be a parabolic curve opening downward according to the Panum's fusional area. The maximum value of the X-weighting, occurring at the most middle position in the x-axis of the 2-D image, can be 1. And the minimum value of the X-weighting, occurring at the x-coordinates of 0 and Dₓ, can be 0 or 0.5. Dₓ is the width of the 2-D image.

In another embodiment, in step S103, the depth value of each block in FIG. 2 is multiplied by a weighting W, wherein the weighting W is a combination of an X-weighting and a Y-weighting, wherein the X-weighting corresponds to a column where each block belongs and the Y-weighting corresponds to a row where each block belongs:

W=a×X_{w}+b×Y_{w}, wherein a+b=1.

In one example, W=0.5×X_{w}+0.5×Y_{w}. In FIG. 2, column C₀ corresponds to X-weighting X_{w,0}, column C₁ and C₋₁ correspond to X-weighting X_{w,1}, column C₂ and C₋₂ correspond to X-weighting X_{w,2}, and so forth. Row R₀ corresponds to Y-weighting Y_{w,0}, rows R₁ and R₋₁ correspond to Y-weighting Y_{w,1}, rows C₂ and C₋₂ correspond to Y-weighting Y_{w,2}, and so forth. Take block B in FIG. 2 as an example, because block B is at column C_{-N} and row R_{M}, the depth value of block B is multiplied by W=0.5×X_{w,N}+0.5×Y_{w,M}. That is, D_{B,adjusted}=(0.5×X_{w,N}+0.5×Y_{w,M})×D_{B}, wherein D_{B,adjusted} is the adjusted depth value of block B and D_{B} is the original depth value of block B. Concerning the values of the X-weightings and the Y-weightings, for example, X_{w,0} is 1 and X_{w,N} is 0, and the values from X_{w,0} to X_{w,N} are descending. Y_{w,0} is 1 and Y_{w,M} is 0, and the values from Y_{w,0} to Y_{w,M} are descending

In another example, in step S103, the depth value of each block is multiplied by a weighting W, wherein the weighting W is a combination of an X-weighting corresponding to an x-coordinate of each block and a Y-weighting corresponding to y-coordinate of each block:

W=a×X_{w}+b×Y_{w}, wherein a+b=1.

FIG. 3a shows the relationship between x-coordinates of the input 2-D image and corresponding X-weightings. FIG. 3b shows the relationship between y-coordinates of the input 2-D image and corresponding Y-weightings. The curve representing the relationship between x-coordinates and corresponding X-weightings can be a parabolic curve opening downward according to the Panum's fusional area. The maximum value of the X-weighting, occurring at the most middle position in the x-axis of the 2-D image, can be 1. And the minimum value of the X-weighting, occurring at the x-coordinates of 0 and Dₓ, can be 0 or 0.5. Dₓ is the width of the 2-D image. The curve representing the relationship between y-coordinates and corresponding Y-weightings can be a parabolic curve opening leftward. The maximum value of the Y-weighting, occurring at the most middle position in the y-axis of the 2-D image, can be 1. And the minimum value of the Y-weighting, occurring at the y-coordinates of 0 and D_{y}, can be 0 or 0.5. D_{y} is the length of the 2-D image.

After adjusting the depth information of the 2-D image in step S103, in step S104 depth image based rendering (DIBR) is used to generate a set of 3-D images according to the adjusted depth information and the 2-D image, wherein the set of 3D images comprises at least a left view image and a right view image. In one embodiment, a left view image can be the original 2-D image, and a right image can be produced by DIBR according to the adjusted depth information and the original 2-D image. Since the depth information is adjusted according to a human visual model, when seeing the set of 3-D images generated by the method described above, a human being may feel more comfortable.

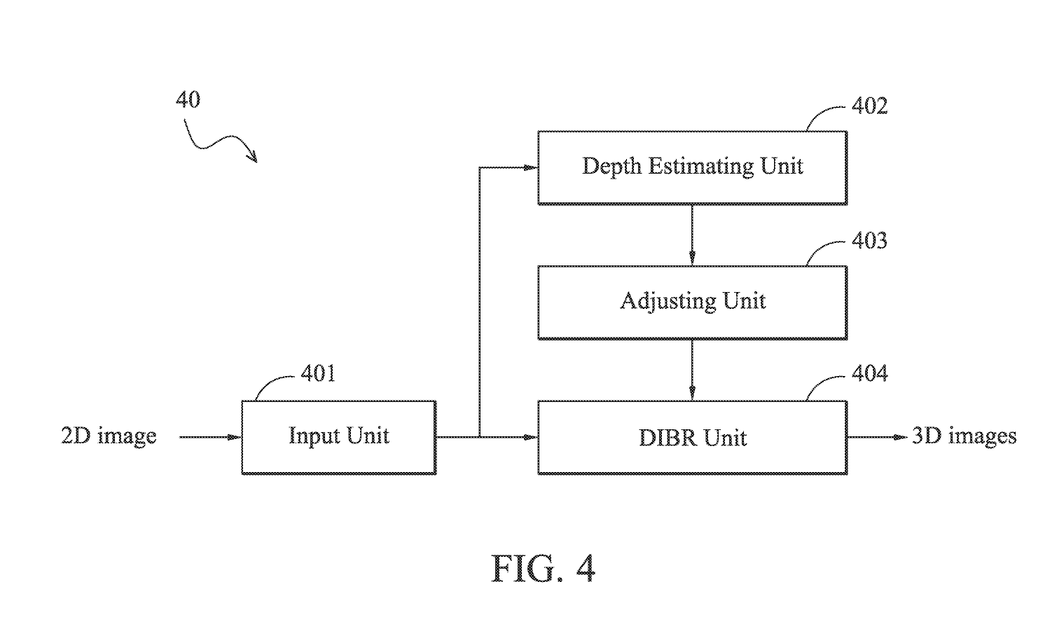

FIG. 4 is a block diagram of an exemplary embodiment of an apparatus 40 for adjusting 3-D images converted from 2-D images.

In FIG. 4, the input unit 401 receives an input 2-D image. In one embodiment, the input unit 401 divides an input 2-D image 20 into blocks, forming a matrix of blocks, as shown in FIG. 2. Each block comprises at least one pixel.

The depth estimating unit 402 is coupled to the input unit 401. The depth estimating unit 402 uses depth estimation, such as estimating depth from blurs or estimating depth based on vanishing points, to obtain depth information of the input 2-D image. For example, the depth estimating unit 402 uses depth estimation to obtain a depth value of each block of the input 2-D image 20 in FIG. 2.

The adjusting unit 403 is coupled to the depth estimating unit 402. The adjusting unit 403 adjusts the depth information of the input 2-D image according to a position of each block to generate adjusted depth information of the input 2-D image.

In one embodiment, the adjusting unit 403 multiplies the depth value of each block of the input 2-D image 20 in FIG. 2 by a corresponding weighting W, wherein the weighting W is a combination of an X-weighting corresponding to a column where each block belongs and a Y-weighting corresponding to a row where each block belongs:

W=a×X_{w}+b×Y_{w}, wherein a+b=1.

Take block B in FIG. 2 as an example, because block B is at column C_{-N} and row C_{M}, the adjusting unit 403 multiplies the depth value of block B by W=0.5×X_{w,N}+0.5×Y_{w,M}. That is, D_{B,adjusted}=(0.5×X_{w,N}+0.5×Y_{w,M})×D_{B}, wherein D_{B,adjusted} is the adjusted depth value of block B and D_{B} is the original depth value of block B. Concerning the values of the X-weightings and Y-weightings, for example, X_{w,0} is 1 and X_{w,N} is 0, and the values from X_{w,M} to X_{w,N} are descending. Y_{w,0} is 1 and Y_{w,M} is 0, and the values from Y_{w,0} to Y_{w,M} are descending.

In another example, the values of the X-weightings and Y-weightings can be obtained according to an x-coordinate and y-coordinate of each block, as shown in FIGS. 3(a) and 3(b). FIG. 3a shows the relationship between x-coordinates of the input 2-D image and corresponding X-weightings. FIG. 3b shows the relationship between y-coordinates of the input 2-D image and corresponding Y-weightings. The curve representing the relationship between x-coordinates and corresponding X-weightings can be a parabolic curve opening downward according to the Panum's fusional area. The maximum value of the X-weighting, occurring at the most middle position in the x-axis of the 2-D image, can be 1. And the minimum value of the X-weighting, occurring at the x-coordinates of 0 and Dₓ, can be 0 or 0.5. Dₓ is the width of the 2-D image. The curve representing the relationship between y-coordinates and corresponding Y-weightings can be a parabolic curve opening leftward. The maximum value of the Y-weighting, occurring at the most middle position in the y-axis of the 2-D image, can be 1. And the minimum value of the Y-weighting, occurring at the y-coordinates of 0 and D_{y}, can be 0 or 0.5. D_{y} is the length of the 2-D image.

The DIBR unit 404 is coupled to the adjusting unit 403 and the input unit 401. The DIBR unit 404 receives the adjusted depth information and the input 2-D image and uses DIBR to generate a set of 3-D images according to the adjusted depth information and the input 2-D image. The set of 3D images comprises at least a left view image and a right view image.

In one embodiment, the apparatus for generating 3-D images converted from 2-D images comprises a processor and a 3-D display coupled to the processor. The processor comprises an input unit 401, a depth estimating unit 402 coupled to the input unit 401, a adjusting unit 403 coupled to the depth estimating unit 402, and a DIBR unit 404 coupled to the adjusting unit 403 and the input unit 401. After the processor adjusts the depth information of the input 2-D image and generates the set of 3-D images, the processor transmits the set of 3-D images to the 3-D display so that the 3-D display can show the set of 3-D images.

Methods and apparatus of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

In one embodiment, the invention provides a computer program product loaded by an electronic apparatus to execute a method for adjusting 3-D images converted from 2-D images, comprising: a first code, receiving an input 2-D image; a second code, dividing the input 2-D image into a plurality of blocks and obtaining a depth value of each of the plurality of blocks, wherein the plurality of blocks forms a matrix; a third code, adjusting the depth value of each of the plurality of blocks according to a position of each of the plurality of blocks and generating adjusted depth information of the input 2-D image, wherein the adjusted depth information comprises an adjusted depth value of each of the plurality of blocks of the 2-D image; and a fourth code, using depth image based rendering (DIBR) to generate a set of 3-D images according to the adjusted depth information and the 2-D image.

Furthermore, the third code further comprises: a fifth code, multiplying the depth value of each of the plurality of blocks by a corresponding weighting, wherein the weighting is a combination of a corresponding X-weighting and a corresponding Y-weighting. The X-weighting corresponding to the central blocks of the plurality of blocks on the x-axis of the 2-D image has the largest value. The further away a block of the plurality of blocks is from the central blocks of the plurality of blocks on the x-axis of the 2-D image, the smaller the value of the X-weighting corresponding thereto is. The Y-weighting corresponding to the central blocks of the plurality of blocks on the y-axis of the 2-D image has the largest value. The further away a block of the plurality of blocks is from the central blocks of the plurality of blocks on the y-axis of the 2-D image, the smaller the value of the Y-weighting corresponding thereto is.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adjusting 3-D images converted from 2-D images, comprising:
inputting a 2-D image;
dividing the 2-D image into a plurality of blocks, forming a matrix of blocks;
obtaining a depth value of each of the plurality of blocks according to a specific algorithm;
adjusting the depth value of each of the plurality of blocks according to a position of each of the plurality of blocks;
obtaining adjusted depth information of the 2-D image, wherein the adjusted depth information comprises an adjusted depth value of each of the plurality of blocks of the 2-D image; and
using depth image based rendering (DIBR) to generate a set of 3-D images according to the adjusted depth information and the 2-D image.

2. The method as claimed in claim 1, wherein the smallest size of each of the plurality of blocks is one pixel.

3. The method as claimed in claim 2, wherein adjusting the depth value of each of the plurality of blocks according to the position of each of the plurality of blocks in the 2-D image further comprises:
multiplying the depth value of each of the plurality of blocks by a corresponding weighting,
wherein the weighting corresponding to the central blocks of the plurality of blocks on the one-dimensional direction of the 2-D image has the largest value, and
wherein the further away a block of the plurality of blocks is from the central blocks of the plurality of blocks on the one-dimensional direction of the 2-D image, the smaller the value of the weighting corresponding thereto is.

4. The method as claimed in claim 3, wherein the largest value of the weighting is 1 and the smallest value of the weighting is 0.

5. The method as claimed in claim 2, wherein adjusting the depth value of each of the plurality of blocks according to the position of each of the plurality of blocks in the 2-D image further comprises:
multiplying the depth value of each of the plurality of blocks by a corresponding weighting, wherein the weighting is a combination of a corresponding X-weighting and a corresponding Y-weighting,
wherein the X-weighting corresponding to the central blocks of the plurality of blocks on the x-axis of the 2-D image has the largest value,
wherein the further away a block of the plurality of blocks is from the central blocks of the plurality of blocks on the x-axis of the 2-D image, the smaller the value of the X-weighting corresponding thereto is,
wherein the Y-weighting corresponding to the central blocks of the plurality of blocks on the y-axis of the 2-D image has the largest value, and
wherein the further away a block of the plurality of blocks is from the central blocks of the plurality of blocks on the y-axis of the 2-D image, the smaller the value of the Y-weighting corresponding thereto is.

6. The method as claimed in claim 5, wherein
the weighting=0.5×X-weighting+0.5×Y-weighting.

7. The method as claimed in claim 5, wherein the largest value of the X-weighting is 1 and the smallest value of the X-weighting is 0.

8. The method as claimed in claim 5, wherein the largest value of the Y-weighting is 1 and the smallest value of the Y-weighting is 0.

9. The method as claimed in claim 1, wherein the set of 3D images comprises at least a left view image and a right view image.

10. An apparatus for generating 3-D images converted from 2-D images, comprising:
an input unit, receiving an input 2-D image;
a depth estimating unit coupled to the input unit, dividing the input 2-D image into a plurality of blocks and obtaining a depth value of each of the plurality of blocks according to a specific algorithm, wherein the plurality of blocks forms a matrix;
an adjusting unit coupled to the depth estimating unit, adjusting the depth value of each of the plurality of blocks according to a position of each of the plurality of blocks and generating adjusted depth information of the input 2-D image, wherein the adjusted depth information comprises an adjusted depth value of each of the plurality of blocks of the 2-D image; and
a DIBR unit coupled to the input unit and the adjusting unit, using depth image based rendering (DIBR) to generate a set of 3-D images according to the adjusted depth information and the 2-D image.

11. The apparatus as claimed in claim 10, wherein the smallest size of each of the plurality of blocks is one pixel.

12. The apparatus as claimed in claim 11, wherein the adjusting unit further multiplies the depth value of each of the plurality of blocks by a corresponding weighting,
wherein the weighting corresponding to the central blocks of the plurality of blocks on the one-dimensional direction of the 2-D image has the largest value, and
wherein the further away a block of the plurality of blocks is from the central blocks of the plurality of blocks on the one-dimensional direction of the 2-D image, the smaller the value of the weighting corresponding thereto is.

13. The apparatus as claimed in claim 12, wherein the largest value of the weighting is 1 and the smallest value of the weighting is 0.

14. The apparatus as claimed in claim 11, wherein the adjusting unit further multiplies the depth value of each of the plurality of blocks by a weighting, wherein the weighting is a combination of a corresponding X-weighting and a corresponding Y-weighting,
wherein the X-weighting corresponding to the central blocks of the plurality of blocks on the x-axis of the 2-D image has the largest value,
wherein the further away a block of the plurality of blocks is from the central blocks of the plurality of blocks on the x-axis of the 2-D image, the smaller the value of the X-weighting corresponding thereto is,
wherein the Y-weighting corresponding to the central blocks of the plurality of blocks on the y-axis of the 2-D image has the largest value, and
wherein the further away a block of the plurality of blocks is from the central blocks of the plurality of blocks on the y-axis of the 2-D image, the smaller the value of the Y-weighting corresponding thereto is.

15. The apparatus as claimed in claim 14, wherein
the weighting=0.5×X-weighting+0.5×Y-weighting.

16. The apparatus as claimed in claim 14, wherein the largest value of the X-weighting is 1 and the smallest value of the X-weighting is 0.

17. The apparatus as claimed in claim 14, wherein the largest value of the Y-weighting is 1 and the smallest value of the Y-weighting is 0.

18. The apparatus as claimed in claim 10, wherein the set of 3D images comprises at least a left view image and a right view image.

19. A computer program product loaded by an electronic apparatus to execute a method for adjusting 3-D images converted from 2-D images, comprising:
a first code, receiving an input 2-D image;
a second code, dividing the input 2-D image into a plurality of blocks and obtaining a depth value of each of the plurality of blocks, wherein the plurality of blocks forms a matrix;
a third code, adjusting the depth value of each of the plurality of blocks according to a position of each of the plurality of blocks and generating adjusted depth information of the input 2-D image, wherein the adjusted depth information comprises an adjusted depth value of each of the plurality of blocks of the 2-D image; and
a fourth code, using depth image based rendering (DIBR) to generate a set of 3-D images according to the adjusted depth information and the 2-D image.

20. The computer program product as claimed in claim 19, wherein the third code further comprises:
a fifth code, multiplying the depth value of each of the plurality of blocks by a corresponding weighting,
wherein the weighting corresponding to the central blocks of the plurality of blocks on the one-dimensional direction of the 2-D image has the largest value, and
wherein the further away a block of the plurality of blocks is from the central blocks of the plurality of blocks on the one-3 dimensional direction of the 2-D image, the smaller the value of the weighting corresponding thereto is.
